(19) United States
(12) Patent Application Publication
(10) Pub. No.: US 2022/0318746 A1
(43) Pub. Date: Oct. 6, 2022

(54) FREIGHT MANAGEMENT USING DYNAMIC ROUTE GUIDES

(71) Applicant: EKA Solutions, Inc., North Salt Lake, UT (US)

(72) Inventors: Steven Weiby, Excelsior, MN (US); Jagjit Singh, North Salt Lake, UT (US); Mark Walker, Tonka Bay, MN (US)

(73) Assignee: EKA Solutions, Inc., North Salt Lake, UT (US)

(21) Appl. No.: 17/701,346

(22) Filed: Mar. 22, 2022

Related U.S. Application Data
(63) Continuation of application No. 16/846,251, filed on Apr. 10, 2020, now abandoned.
(60) Provisional application No. 62/832,200, filed on Apr. 10, 2019.

(51) Int. Cl. G06Q 10/08; G06Q 50/28

(52) U.S. Cl. CPC G06Q 10/0835; G06Q 50/28; G06Q 10/0838; G06Q 10/08345

(57) ABSTRACT

A technology is described for a transportation management service. In one example, parameters can be received for transporting a load from an origin location to a destination location. In response, carriers that have available capacity to transport the load can be identified based on the parameters. Meta tags included in a strategic capacity profile defining a strategy for transporting the load can be retrieved. The strategy may be defined by the meta tags, which describe carrier attributes used to select a carrier to transport the load. The meta tags can be used to identify a set of carriers that have attributes that correspond to the meta tags and who are eligible to transport the load based on the parameters. The carrier data for the set of carriers can be provided to a user to allow a selection of one or more carriers to send tenders.

### PRIORITY DATA

This application is a continuation of U.S. patent application Ser. No. 16/846,251, filed Apr. 10, 2020, which claims the benefit of U.S. Provisional Patent Application Ser. No. 62/832,200, filed Apr. 10, 2019, each of which is incorporated herein by reference in their entirety.

### BACKGROUND

The United States truckload freight industry has a set of characteristics that yields a dynamic and complicated marketplace. There are significant challenges to planning availability and driving capacity of drivers. The driver, equipment, handling, and scheduling details require that significant effort is put into matching these requirements to the proper available capacity. The matching challenge is anchored in the huge number of trucking companies. About one third of the marketplace capacity is provided by small carriers and an additional one third is supplied by other carriers that have additional trucks but typically no more than a hundred. This diverse source of capacity yields a robust spot market that fluctuates constantly and a broad network of brokers that intermediate a quarter of the industry.

### BRIEF DESCRIPTION OF THE DRAWINGS

Features and advantages of invention embodiments will be apparent from the detailed description which follows, taken in conjunction with the accompanying drawings, which together illustrate, by way of example, invention features; and, wherein:

FIG. 1 is a block diagram illustrating an example system used to host a transportation management service, in accordance with an example of the present disclosure.

FIG. 2 is a diagram that illustrates an example carrier record that includes meta tags that describe various attributes of a carrier, in accordance with an example of the present disclosure.

FIG. 3 is a diagram illustrating an example user interface used to filter a list of carriers using a strategic capacity profile, in accordance with an example of the present disclosure.

FIG. 4 is a flow diagram illustrating an example method for a dynamic route guide, in accordance with an example of the present disclosure.

FIG. 5 is a diagram that illustrates an example price filtering tool used to provide historical paid capacity price per mile for a given origin and destination pair, in accordance with an example of the present disclosure.

FIG. 6 is a diagram illustrating an example group tender tool for selecting carriers using a strategic capacity profile and transmitting tenders to the carriers, in accordance with an example of the present disclosure.

FIG. 7 is a flow diagram illustrating an example method for updating carrier data displayed in a graphical user interface in response to a meta tag being dynamically updated.

FIG. 8 is a flow diagram that illustrates an example method for identifying a set of carriers to transport a load using a transportation management service, in accordance with an example of the present disclosure.

FIG. 9 is block diagram illustrating an example of a computing device that may be used to execute the methods described herein, in accordance with an example of the present disclosure.

### DESCRIPTION OF EMBODIMENTS

Before invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall inventive concepts articulated herein, but are merely representative thereof.

As used in this written description, the singular forms “a,” “an” and “the” include express support for plural referents unless the context clearly dictates otherwise. Thus, for example, reference to “a network” includes a plurality of such networks.

Reference throughout this specification to “an example” means that a particular feature, structure, or characteristic described in connection with the example is included in at least one invention embodiment. Thus, appearances of the phrases “an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various invention embodiments and examples can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

### EXAMPLE EMBODIMENTS

An initial overview of the technology is provided below and specific technology embodiments are then described in further detail. This initial summary is intended to aid readers in understanding the technologies more quickly, but is not intended to identify key or essential technological features, nor is it intended to limit the scope of the claimed subject matter.

Technologies for a transportation management service are described. In one example, a transportation management service can include a cloud software service developed to serve the Transportation Management System (TMS) needs of small to medium businesses with network accessible tools. The transportation management service can help a business plan, optimize, manage, report, and account for the movement of goods. Historically, larger shippers, carriers and freight brokers commonly utilized transportation management systems to improve their business performance. The advent of cloud based Software as a Service (SaaS) provides access to TMS capabilities with less capital which opens the door for smaller businesses to enjoy tools and capabilities that support their freight management objectives. The transportation management service described herein operates as a unified platform in that it is built for all parties of a transaction to interact digitally. When trading partners are subscribers to the transportation management service, their transactions share the benefit of automated data exchange. The transportation management service can be used to service shippers, carriers, and brokers that concentrate on the trucking transportation market, as well as other markets, such as, rail transportation, ship transportation, and air transportation.

Some of the factors considered when selecting a carrier can include:

cargo handling factors, such as, equipment specifications and driver qualification that limits which trucks can handle specific shipments;

demand characteristics, such as, seasonality (e.g., agricultural and consumption seasonality) which can drive regional markets, business cycles (e.g., weekly, monthly, and quarterly cycles) that exacerbate broader demand changes, particularly near the end of a period, and trends and fashion;

supply variables, such as, transit time uncertainty; unpredictable drive times (e.g., congestion), unpredictable pickup and delivery times (e.g., warehouse queues, storms and weather that disrupt arrival schedules), equipment failure and vehicle safety standards enforcement;

driver availability, such as, regulations (drivers time is strictly limited by day and week), driver turnover, and barriers to entry (e.g., safety focused eligibility requirements);

pricing volatility (e.g., the supply and demand factors lead to local, regional and national imbalances that are constantly vetted out in spot markets that adjust constantly); and

freight brokerage (e.g., a large number of registered freight brokerage firms spend their days building and applying their knowledge of freight markets to effectively match demand to supply.

### Past Solutions

The combination of listed dynamics makes the truckload freight market difficult to plan and manage. Neither the demand for shipments from a specific shipper nor the supply of capacity from specific carriers at the right time and place can be easily predicted to allow for smooth contracting. The complexity of the situation has historically been resolved using three methods: route guides, load boards, and lane histories.

Static route guides are structured allocations of shipments to specific carriers in specific lanes. When shipment orders for a planned lane are received the shipments are then distributed to carriers based upon a hierarchy that was previously established. Static route guides have been used when shipment volumes and carrier capacity are larger and more consistent. Static route guides provide static pricing for shipments and the process reduces stress between parties. Static route guides often use a shot clock for response time and cascade from carrier to carrier. However, static route guides use human administration to allocate shipments to carriers, so any uncertainty becomes a barrier. Static route guides have made it difficult to introduce additional carriers mid cycle without upsetting the other carriers in the guide. When markets move quickly, the administration burden associated with static route guides has resulted in a lagging response to the market. When static route guides fail to achieve an allocation, the structured time is wasted, which can lead to a need to expedite orders at great expense.

Load boards are online and/or e-mailed lists that allow shippers and brokers to post loads and carriers to post trucks. There are public load boards that are available as subscription services in a broad many-to-many relationships and private load boards that are one-to-many. Load boards can be a low cost way to get broad market exposure to freight and capacity, and administration may be tied to current need. However, postings are typically manual login and data entry, and often several identical postings are made in competing platforms. Also, since they are manual, posting updates lag the change in actual availability, which often leads to frustrating communication and wasted effort. The broad lists of available loads and available trucks leave all parties to spend considerable effort sifting through lists to identify were they are willing to negotiate. Since there are many transactional engagements where parties have little or no historical foundation, the negotiation process is often strained by the uncertainty of intent and performance. Frequently the matching process connects businesses for the first and last time, yielding higher risk and contracting cost for both parties.

In the past, lane history has been a popular tool of freight brokers. Likely capacity for current freight is identified in the history of carriers that have hauled similar shipments in the recent past. Lane history provides established track records for informing a buying decision and changing search criteria allows the scope of relevant history to be contracted or expanded. However, defining the most appropriate search criteria for the freight and market conditions is an art form that requires experience. Once an effective list of carriers is defined, the process of prioritizing and contacting the carriers is labor and time intensive.

### Examples of the Technology

The following examples pertain to specific invention embodiments and point out specific features, elements, or steps that can be used or otherwise combined in achieving such embodiments. In one example, a transportation management service can be provided as software as a service (SaaS) hosted in a computing service provider environment (e.g., a “cloud” environment). The transportation management system may include tools that allow users to develop capacity strategies for repeated transportation scenarios. In one example, a user can create a strategic capacity profile that defines a strategy for transporting a load. The strategy can be defined using meta tags that describe carrier attributes. The meta tags can be used to select a carrier that has the carrier attributes to transport the load.

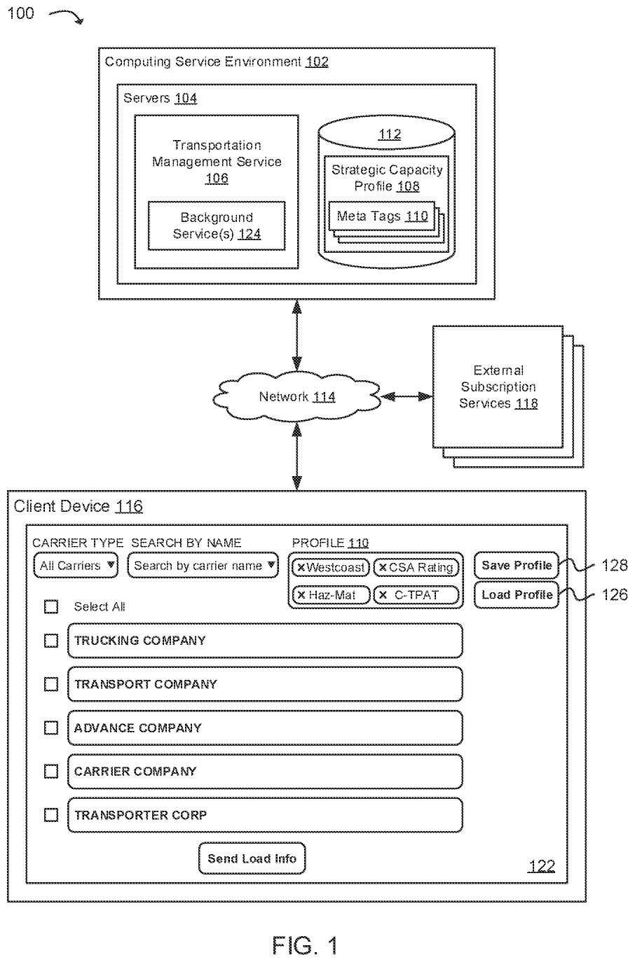

To further describe the present technology, examples are now provided with reference to the figures. FIG. 1 is a block diagram illustrating an example of a system 100 on which the present technology may be executed. As illustrated, the system 100 can include a transportation management service 106 hosted on one or more servers 104 located in a computing service environment 102. In one example, the transportation management service 106 may be a software as a service (SaaS). A SaaS model allows installation and operation of application software in the computing service environment 102. End users can access the transportation management service 106 using client devices 116, such as desktop computers, laptops, tablets, smartphones, etc. running web browsers or other lightweight client applications. Those familiar with the art will recognize that the computing service environment 102 may be described as a “cloud” environment.

A graphical user interface 122 executed on a client device 116 may allow tendering of a freight load to a carrier using a strategic capacity profile 108 for a load transportation scenario, as described in more detail later. The graphical user interface 122 can be used to select meta tags 110 that describe carrier attributes and the meta tags 110 can be used to create a strategic capacity profile 108 for a load transportation scenario. In one example, the meta tags 110 may be dynamic, such that the meta tags 110 are dynamically updated with carrier information which causes the carrier information displayed in the graphical user interface 122 to be dynamically updated. A user can use the graphical user interface 122 to create a strategic capacity profile 108 for a load transportation scenario, and the strategic capacity profile 108 can then be used to target specific carriers without having to replicate search criteria at each step. The graphical user interface 122 can then be used to tender a load to a selected carrier, as described below.

### Generating Meta Tags for Carriers

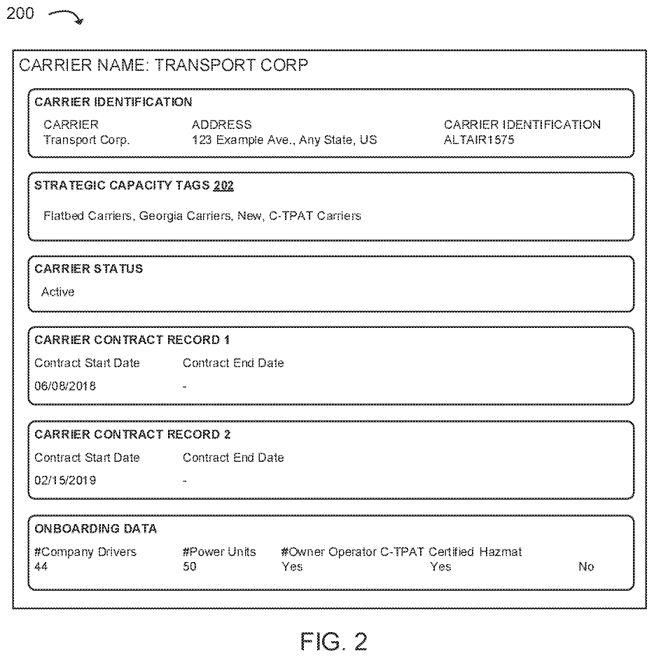

The transportation management service 106 can be configured to generate meta tags 110 for carriers to describe carrier attributes, including service attributes, qualification attributes, risk attributes of carriers, as well as other carrier attributes. In one example, carrier attributes can be manually input (e.g., via a user interface) and the transportation management service 106 may generate static meta tags 110 that represent the carrier attributes and the transportation management service 106 can assign the static meta tags 110 to the carriers (e.g., added to carrier data records 200 as shown in FIG. 2).

In another example, the transportation management service 106 can generate dynamic meta tags 110 which describe the attributes of the carriers, and the dynamic meta tags 110 can be assigned to the carriers (e.g., added to carrier data records as shown in FIG. 2) to allow the carriers to be identified using the dynamic meta tags 110. For example, the transportation management service 106 may be configured to obtain carrier attributes for one or more carriers from an external subscription service 118 and generate dynamic meta tags 110 for the carriers. For example, carrier attributes can be automatically obtained from external data subscription services 118, such as DAT CarrierWatch, MyCarrierPackets.com, SaferWatch or Risk Monitoring Insurance Services that provide information regarding the insurance carried, qualifications obtained and additional services provided by a carrier. In one example, one or more background service 124 (e.g., software agents) can be configured to perform queries against data obtained from the external subscription services 118 and the transportation management service 106 may identify carriers with specific attributes (e.g., equipment type, shipping regions, shipping lanes, Haz-Mat, C-TPAT, Compliance, Safety, Accountability (CSA) rating, etc.). As a specific example, a background service 124 of the transportation management service 106 can query an external subscription service 118 for carriers that are qualified to handle hazardous materials and assign dynamic meta tags 110 to carrier records associated with the carriers indicating that the carriers are qualified to handle the hazardous materials. Thereafter, the dynamic meta tags 110 assigned to the carriers can be used to identify the carriers as being able to handle hazardous materials.

Dynamic meta tags 110 for carriers can be can be automatically updated to add, delete, and/or modify carrier attributes. Automatically updating meta tags 110 may change the attributes of a carrier which may qualify or disqualify the carrier from transporting a load. As an example, updating a dynamic meta tag 110 indicating a CSA rating for a carrier may qualify or disqualify the carrier from transporting a freight load based on the CSA rating of the carrier indicated by the dynamic meta tag 110. A dynamic meta tag 110 can be updated anytime that a carrier attribute changes. In one example, the transportation management service 105 (e.g., via a background service 124) may periodically query data obtained from an external subscription service 118 to determine whether the attributes of a carrier have changed and update corresponding dynamic meta tags 110 to indicate the change in carrier attributes. Illustratively, the transportation management service 106 may check for updates to carrier attributes server times an hour, once an hour, nightly, weekly, monthly, or when data is received (e.g., pushed) from an external subscription service 118.

In one example, dynamic meta tags 110 can contain a list of carriers that have reviewed loads in the system or participated in pricing and negotiation activity that failed to commence a transaction, so therefore would not be recorded in a carrier transaction history. As a specific example, a dynamic meta tag 110 for a carrier may include proposed pricing for freight loads shipped via a specific shipping lane, and the carrier's proposed pricing on a previous transaction can be used to determine whether the carrier meets the pricing parameters of a freight load.

In one example, meta tags 110 containing carrier transaction information and carrier activity information can be tiered or gradated within an attribute to improve prioritization of carriers. As a specific example, carriers that have submitted pricing in the same lane may be segmented into different meta tags 110 by the frequency or consistency of such price submissions to distinguish the relative likelihood of completing a transaction with the carriers in one list versus those in another.

Meta tags 110, in one example, may be generated for a specific customer or entity to allow the meta tags 110 to be used in one or more strategic capacity profiles 108 for the customer or entity. In another example, meta tags 110 can be generated and provided to any customer or entity who uses the transportation management service 106 (e.g., any subscriber or entity of a transportation management service platform).

### Custom Strategic Capacity Profiles

The transportation management service 106 may allow a user to create a strategic capacity profile 108 for a load transportation scenario and/or dynamically generate a strategic capacity profile 108 for a load transportation scenario. A strategic capacity profile 108 may define a strategy for transporting a load from an origin to a destination using a plurality of meta tags 110 that describe carrier attributes. The carrier attributes described by the meta tags 110 can be used to identify one or more carriers that have attributes that correspond to the carrier attributes described by the meta tags 110. As an illustration, a strategic capacity profile 108 may include meta tags 110 having information can be used to identify a carrier is qualified to: handle hazardous materials, is C-TPAT Certified, has an acceptable CSA rating, or handle over-dimensional cargo, as well as other qualifications. Instead of selecting individual meta tags 110, the strategic capacity profile 108 can be employed to identify carriers that have the attributes described by the meta tags 110. As described earlier, the meta tags 110 may be dynamic meta tags 110, and as such, the strategic capacity profile 108 can be dynamically updated when a dynamic meta tag 110 included in the strategic capacity profile 108 is updated.

In one example, a user can manually build a strategic capacity profile 108 using the graphical user interface 122. For example, a user can select meta tags 110 that describe carrier attributes that correspond to the user's transportation requirements and add the meta tags 110 to the strategic capacity profile 108 (e.g., add the meta tags 110 to a control element in the graphical user interface 122). After adding the meta tags 110 to the strategic capacity profile 108, the strategic capacity profile 108 can be saved for future use (e.g., via a save profile button 128 in the graphical user interface 122). The transportation management service 106 can store the manually generated strategic capacity profile 108 to a data store 112 to allow the strategic capacity profile 108 to be retrieved and used for future queries. Thereafter, a user can load the strategic capacity profile 108 (e.g., via a load profile button in the graphical user interface 122) and the strategic capacity profile 108 can be used to identify qualified carriers to transport a load without having to initiate individual queries, saving the user time and effort associated with having to select individual meta tags 110 each time a user wants to tender a freight load to a carrier.

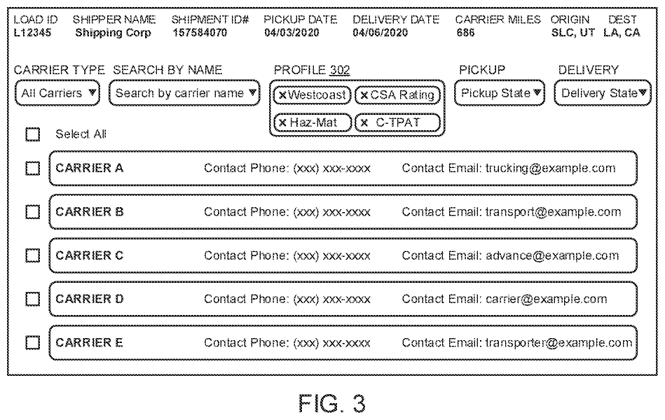

A strategic capacity profile 108 can be used in conjunction with other search criteria to narrow or extend the focus of a search for carriers to transport a load. For example, a filtering technique that uses meta tags 110 included in a strategic capacity profile 108 and additional search parameters, such as carrier load history, recorded available capacity, etc. can be used to identify a list of carriers. Also, the strategic capacity profile 108 can be applied as a filter (as shown in FIG. 3) to target specific carriers without having to replicate search criteria at each step.

In another example, the transportation management service 106 may be configured to dynamically generate a strategic capacity profile 108 for a load transportation scenario using transportation parameters provided by a user and meta tags 110 that correspond to the transportation parameters. For example, the transportation management service 106 may evaluate the transportation parameters to identify attributes (e.g., origin, destination, freight weight, freight type, pickup date, delivery date, etc.) that can be used to identify a freight transportation method which can be utilized to transport a freight load. After the attributes have been identified, the transportation management service 106 can map the attributes to meta tags 110 and generate a strategic capacity profile 108 that defines a strategy for transporting the freight load. As an example, a user may input load details to the graphical user interface 122 (or upload a load profile to the transportation management service 106) where the load details may include an origin, destination, freight type and weight. The transportation management service 106 may evaluate the load details and map the origin, destination, freight type and weight to corresponding meta tags 110 assigned to carriers. The transportation management service 106 can then generate a strategic capacity profile 108 to include the meta tags 110. The dynamically generated strategic capacity profile 108 can then be used to identify a list of carriers assigned the meta tags 110 and a user can tender the load to one or more of the carriers. The transportation management service 106 can store the dynamically generated strategic capacity profile 108 to a data store 112 to allow the dynamically generated strategic capacity profile 108 to be retrieved and used for future queries. As described earlier, meta tags 110 included in a strategic capacity profile 108 can include dynamically generated meta tags 110, and as such, the strategic capacity profile 108 can be dynamically updated when one or more of the meta tags 110 included in the strategic capacity profile 108 is updated.

Shippers and freight brokers can develop considerable skill in how they choose to source carrier capacity based upon the freight characteristics and condition of the trucking capacity market. If a user exposes freight too broadly then the user wastes time negotiating with extraneous parties, whereas if the user exposes the freight too narrowly then critical coverage time may be lost and the cost to cover increases. Shippers and brokers can more effectively target the likely carriers first and then focus in on the right balance of market exposure. The common methods of targeted searching of the most likely carriers include: load histories-carriers that have previously hauled the exact same origin and destination point pair, and lane histories-carriers that have previously hauled for the broker identified by other criteria, such as State A to State B, Zip Code 123XX to Zip Code 456XX, carriers that haul ice-cream at −10 degrees. Load and lane history searches consistently fail to capture carriers that have demonstrated interest in opportunities but have not yet completed a transaction.

Additionally, shipment level characteristics can differentiate which carriers may have, or not have, a high degree of interest in hauling a load. For example, shipment level characteristics can indicate whether a carrier has had a positive or negative experience hauling a commodity type, or whether the carrier has a prior positive or negative experience at a particular warehouse, or whether transportation locations for a freight load align with routes the carrier likes to drive. The more specific a shipper or broker can be in targeting a search, the quicker and better priced their carrier selection will be. Experienced users can apply their knowledge to build a strategic capacity profile 108 to more effectively support the retention and re-use of the user's experience. The next time that the user identifies the need for the same strategy, a strategic capacity profile 108 allows the user to use the strategic capacity profile 108 to identify qualified carriers.

A strategic capacity profile 108 is not limited to any one specific user. Other user of an organization can use the strategic capacity profile 108 to identify qualified carriers to allow the organization to support less experienced users with already validated strategic capacity profiles 108, making the user more productive and providing them with examples of how they too can build strategies as additional market opportunities are developed. The improved qualification efficiency is felt equally by carrier and shipper or broker. Carriers can be added to strategic capacity profiles 108, but several meta tags can also be added to a carrier so discovery and evaluation of a carrier's interests and abilities can be translated into aligning them with all the most relevant capacity strategies early in the relationship. The alignment can be established before they even have the benefit of a transaction history. Since the builder of the strategy and the implementer of the strategy can be separate users, the transportation management service 106 can support a more effective division of labor. A user that is particularly effective in the discovery process can identify the appropriate carriers to fit into each strategy, while a user who may be a more effective negotiator can focus on closing transactions.

### Price Assistance Using a Strategic Capacity Profile

The dynamics of the trucking market include pricing and negotiating activity. Shippers often set cost allocations for products. Brokers and carriers often compete to win freight allocations. Shippers and Brokers often purchase trucking capacity. Having misaligned prices can have negative consequences or all parties. The transportation management service 106 can be used to provide visible business intelligence support to users to generate more effective bid and ask prices.

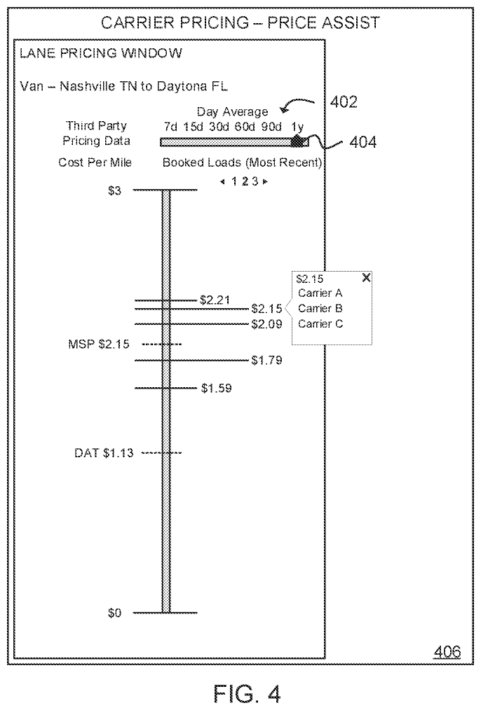

In one example, the transportation management service 106 can include a price assist tool used to provide a subscribing company's historical paid capacity price per mile for a given origin and destination pair, which can be graphed to allow a user to view a range and density of paid prices for a given period. As shown in FIG. 4, a period 402 can be adjusted with a slide bar 404 to allow a user to view pricing information within a time frame. As can be appreciated, the period 402 can be for any time period. Illustratively, for each transaction in a lane pair, a user can drill in to observe: a selected carrier and price, other carriers that participated in the negotiation and their final price offers, and the actual negotiation bid/ask cycle with each carrier.

The price assist tool 406 can provide a management suggested price, which can be captured in a table that allows management to translate broader business objectives into the transactional behavior across the enterprise. The price assist tool 406 can provide lane level market pricing data from external subscription services 118. For example, there are multiple services that a company can subscribe to which provide lane level pricing and trend information. The transportation management service 106 can integrate external data into the price assist tool 406 to make the external data simultaneously visible with the internal data. In one example, the data provided via the price assist tool 406 can include average pricing for transporting a load by carriers. The average pricing can be calculated using final carrier bid data included in historical transaction data for the carriers. Also, in one example, the price assist tool 406 can be used to determine a price at which to offer a tender for transporting the load, wherein the price is based in part on average pricing for transporting the load by one or more carriers.

The price assist tool 406 can use a strategic capacity profile 108 to filter historical data to only carriers having carrier attributes that correspond to meta tags 110 included in the strategic capacity profile 108. Also, in some examples, the price assist tool 406 can have a strategic capacity profile 108 applied such that transactions of carriers that have attributes described by meta tags 110 in the strategic capacity profile 108 can be included in the lane history. For example, a filter technique which adds meta tags 110 included in a strategic capacity profile 108 to a search of carriers can be used to generate a list of carriers within a load history, generate a list of carriers that have recorded available capacity in a location, or generate a list of carriers that have available equipment to transport a freight load. When shippers and brokers are establishing pricing, one of their greatest challenges is gathering the most relevant context to inform a decision. They want to include enough carrier data to provide confidence while constraining the carrier data to be the most relevant carrier data.

### Group Tender Using a Strategic Capacity Profile

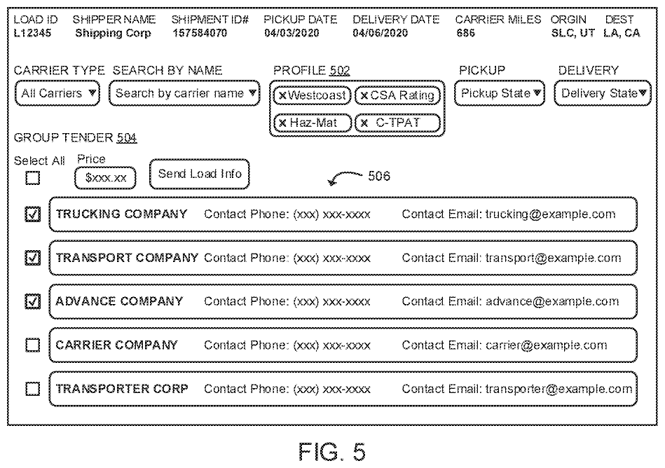

The transportation management service 106 can include a group tendering tool used to post a freight load to a list of selected carriers 506, as shown in FIG. 5. When a shipper or broker wants to purchase capacity in the marketplace, a strategic capacity profile 108 can work seamlessly with the group tendering tool to post available freight to a targeted list of selected carriers. A user can select a strategic capacity profile 502 and carrier information for carriers that have carrier attributes described by the meta tags included in the strategic capacity profile 502 can be uploaded to the group tendering tool. Within the group tendering tool, the user can select individual carriers, or use a “select all” checkbox to further refine the list of carriers 506. After determining an appropriate price to begin negotiations, which as described above, can be determined automatically, the user can initiate a group tender 504 to the selected carriers (e.g., via a send load info button). The tenders can be transmitted to each selected carrier to review in their own carrier portal.

In one example, a group tender can be integrated into a stored rate proposal for a specific lane and service combination, so that the application of pricing the group tender is automated and negotiations can be initiated simultaneously with all carriers included in the metatag 110. rate contract. As one example, strategic capacity profile comprising a static list of meta tags can be constructed to include specific list of carriers considered to be of equal preference for a given load profile. The strategic capacity profile can then be used to group tender a freight load to the carriers identified by the strategic capacity profile. As another example, a dynamic strategic capacity profile comprising a list of meta tags that define a prequalified subset of carriers can be used to group tender a freight load to the subset of carriers.

The group tendering process can take mere seconds to assess the market, target a precise list of relevant carriers, and initiate a capacity strategy that is as focused or broad as the user deems appropriate for market conditions. Such targeted batch negotiation strategies avoid considerable labor compared to typical carrier-by-carrier negotiations. Targeted batch negotiation can also avoid adding to the market noise that is inherent with posting to public load boards.

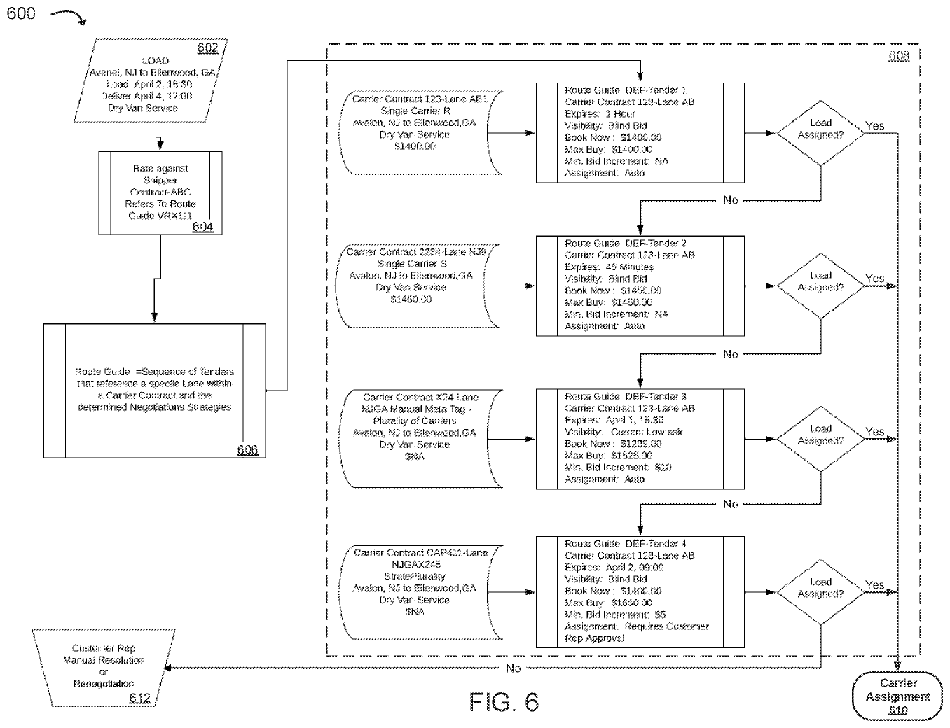

FIG. 6 is a flow diagram that illustrates an example method 600 for a dynamic route guide that utilizes a strategic capacity profile to identify a list of carriers and sends a sequence of tenders to the carriers in an attempt to assign a freight load to one of the carriers. The transportation management service 106 described in association with FIG. 1 can include modules configured to perform the method 600 for a dynamic route guide.

As in block 602, information for a freight load that includes transportation parameters (e.g., origin location, destination location, pickup data, delivery date, equipment type, etc.) can be combined with a strategic capacity profile, as in block 604, to generate a dynamic route guide, as in block 606. The dynamic route guide can include a sequence of tenders that reference specific shipping lanes in which carriers operate, and can include determined negotiation strategies (e.g., an appropriate price to begin negotiations) which can be used with the carriers.

As in blocks 608, a sequence of tenders can be sent to the carriers. As illustrated, a carrier contract for a first carrier can be obtained and a tender can be generated using parameters extracted from the carrier contract (e.g., bid type, book price, bid increment, max buy price, etc.). The tender can then be sent to the carrier. In one example, a carrier hierarchy, based upon the load acceptance history of the included carriers, can be used to determine an order in which to send the sequence of tenders to the carriers In the case that the freight load is not assigned to a first carrier (e.g., the carrier declined the offer), then a subsequent tender can be generated using parameters for a carrier contract for a second carrier and the tender can be sent to the second carrier. The process above can be repeated until either a carrier accepts the tender to transport the freight load and the load is assigned to the carrier, as in block 610, or assignment of the freight load fails and, as in block 612, a manual resolution or renegotiation is performed.

The dynamic route guide described above provides integrated process workflows that work at a transaction level to democratize the application of automated procurement techniques across a diverse set of freight and carriers. Selection of a strategy via a strategic capacity profile limits which additional fields and subsequent options are used to tender a freight load thereby reducing an amount of work (e.g., keystrokes) needed to tender the freight load. The process of tendering a freight load is made more agile by utilizing meta tags to adjust the number of participants which provides the ability to dial market pressure up or down as the market dictates. Negotiations typically do not have provisions to include email and manual negotiation updates, which isolates participants. The present technology allows for email and manual updates to include chat, text, and telephonic negotiations that encompass the wide range of communication techniques small businesses utilize. By incorporating target, step, and limit values, a freight tender can be submitted to be effective over a range of prices rather than at a single take it or leave it price. The option to submit automated approval and pre-declared two-layer approval to the negotiation process aligns approval to market conditions and adds delegation that can be executed among a few coworkers or across large teams. Selecting the degree of negotiation transparency for participants allows the user an extremely simple method to shield or expose competitive activity to their advantage.

Delivering sequential tenders at contracted rates to individual carriers can yield inadequate results because the carriers may be faced with a take it or leave it price and may be slow to get freight to market. This inflexibility may result in the need to expedite freight at great expense. Dynamic route guides improve the automated allocation of freight by enabling more flexibility to the tendering process within a route guide in ways that codify and control behaviors that previously were relegated to isolated, inconsistent and manual activities. Enabling contracts to be applied to one or many carriers allows a fluid and timely escalation of the number of competitive participants from one tender phase to a next tender phase. By allowing a user to apply different negotiation strategies at each tender phase, the dynamic route guide adds controlled elasticity to subsequent phases of the route guide.

As an example scenario using a dynamic route guide, a shipper or freight broker can establish a dynamic route guide to serve a defined shipping lane. The dynamic route guide issues a first phase that references a single carrier and negotiation strategy. Negotiations for the freight load are exclusively active with the identified carrier. Should the carrier reject or fail to respond within the parameters of the first phase, then the first phase fails and the negotiation is closed, which triggers a second phase. The second phase similarly is a single carrier and negotiation strategy. Negotiations for the freight load are exclusively active with the identified carrier. Should the carrier reject or fail to respond within the parameters of the second phase, then the second phase fails and the negotiation is closed, which triggers a third phase. In contrast to the second phase, the third phase tenders the freight load to a meta tag that currently includes a list of carriers with a common negotiation strategy. Negotiations are opened with the carriers simultaneously. Should the third phase fail to attract an acceptable offer, the negotiation is closed and a fourth phase of the dynamic route guide is triggered. The fourth phase is tendered to a strategic capacity profile that identifies a broader number of carriers and the tender is extended to the carriers.

Structured transaction data accumulated in the process of executing the dynamic route guides can be used to apply machine learning and artificial intelligence to autonomously build, adapt, and deploy tendering phases of dynamic route guides. The accumulated structured transaction data may provide a breadth and depth of freight negotiation detail in a highly structured fashion across thousands of businesses. Due to the observation of the trading methods across different market conditions, the structured transaction data can be used with automated model building tools to format optimal negotiation structures for different market conditions and load requirement scenarios. For example, the structured transaction data can be used to train a machine learning model to generate pricing predictions for carriers and the machine learning model can be employed as a pricing tool used in carrier negotiations.

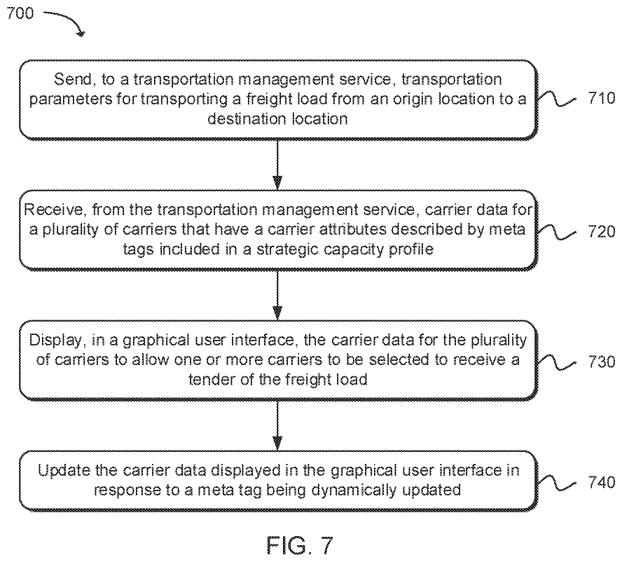

FIG. 7 is a flow diagram illustrating an example method 700 for updating carrier data displayed in a graphical user interface in response to a meta tag being dynamically updated. As in block 710, transportation parameters for transporting a freight load from an origin location to a destination location can be sent from the graphical user interface to a transportation management service. In response to receiving the transportation parameters, the transportation management service identifies a strategic capacity profile that corresponds to the transportation parameters. The strategic capacity profile defines a strategy for transporting the freight load using one or more meta tags describing a carrier attribute. One or more of the meta tags may be dynamically updated to indicate changes to the carrier attribute described by the meta tags;

As in block 720, the graphical user interface receives carrier data for a plurality of carriers from the transportation management service. The carriers associated with the carrier data have the carrier attribute described by the meta tags included in the strategic capacity profile. As in block 730, the carrier data for the plurality of carriers can be displayed in the graphical user interface to allow one or more carriers to be selected to receive a tender of the freight load. As in block 740, the carrier data displayed in the graphical user interface can be updated in response a meta tag included in the strategic capacity profile being dynamically updated. For example, carrier data associated with a meta tag that is updated may also be updated to reflect a change made to the meta tag.

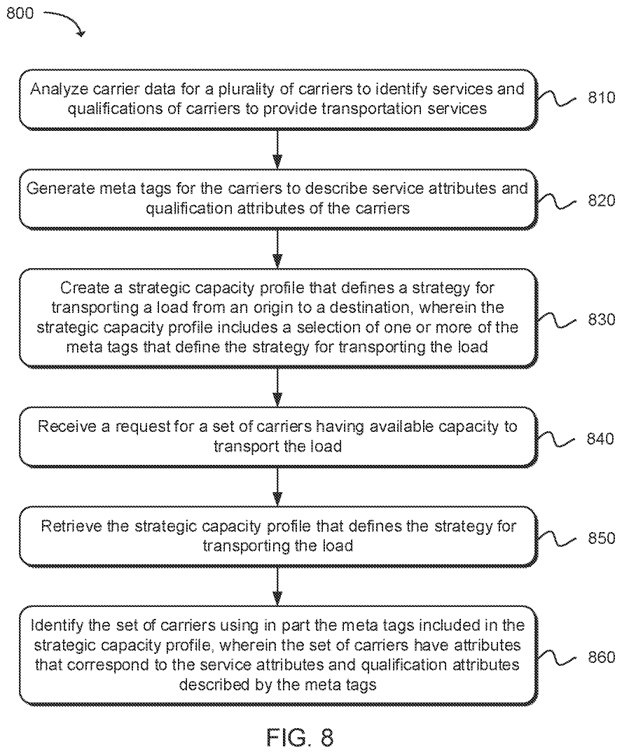

FIG. 8 is a flow diagram illustrating an example method 800 for a transportation management service used to identify a set of carriers to transport a load. As in block 810, carrier data for a plurality of carriers can be analyzed to identify services and qualifications of carriers to provide transportation services. As in block 820, meta tags can be generated for the carriers to describe service attributes and qualification attributes of the carriers. In one example, a graphical user interface can be provided to a user for creating a meta tag and assigning the meta tag to a carrier.

As in block 830, a strategic capacity profile can be created to define a strategy for transporting a load from an origin to a destination, wherein the strategic capacity profile can include a selection of one or more of the meta tags that define the strategy for transporting the load. In one example, a graphical user interface can be provided to a user for creating a strategic capacity profile, allowing the user to select meta tags to include in the strategic capacity profile. In another example, creating a strategic capacity profile can include analyzing historical carrier transaction data using machine learning to identify carrier attributes associated with optimized shipping performance, and generating the strategic capacity profile to include a set of meta tags that describe carrier attributes.

As in block 840, a request can be received for a set of carriers having available capacity to transport the load. As in block 850, the strategic capacity profile can be retrieved that defines the strategy for transporting the load. In one example, the set of carriers can be identified using predictive analytics that selects the strategic capacity profile from a plurality of strategic capacity profiles.

As in block 860, the set of carriers can be identified using in part the meta tags included in the strategic capacity profile, wherein the set of carriers have attributes that correspond to the service attributes and qualification attributes described by the meta tags. In one example, an average price range for transporting the load can be calculated for each carrier in the set of carriers using historical transaction data associated with the set of carriers, and the average price range for the set of carriers can be provided to a user. A tender offer price range for transporting the load can be generated, and the tender offer price range can be based in part on historical transaction data associated with the set of carriers. The tenders can be sent to the set of carriers, wherein a tender can be transmitted to a carrier portal to allow a carrier to evaluate the tender.

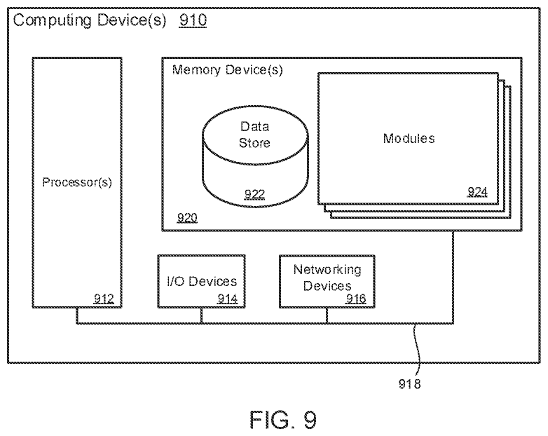

FIG. 9 illustrates a computing device 910 on which modules of the technology described in this disclosure may execute. A computing device 910 is illustrated on which a high level example of the technology may be executed. The computing device 910 may include one or more processors 912 that are in communication with memory devices 920. The computing device 910 may include a local communication interface 918 for the components in the computing device. For example, the local communication interface 918 may be a local data bus and/or any related address or control busses as may be desired.

The memory device 920 may contain modules 924 that are executable by the processor(s) 912 and data for the modules 924. For example, the memory device 920 can include one or more modules for a transportation management service. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high-level programming languages that are compiled, interpreted or executed using a hybrid of the methods.

The computing device 910 may also have access to I/O (input/output) devices 914 that are usable by the computing device 910. Other known I/O devices may be used with the computing device 910 as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described herein may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, optical storage, magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

### EXAMPLES

The following examples pertain to specific invention embodiments and point out specific features, elements, or steps that can be used or otherwise combined in achieving such embodiments.

In one example there is provided, a system for freight transportation management, comprising:

at least one processor;

a memory device including instructions that, when executed by the at least one processor, cause the system to:

receive transportation parameters for transporting a freight load from an origin location to a destination location;

identify a strategic capacity profile that corresponds to the transportation parameters, wherein the strategic capacity profile defines a strategy for transporting the freight load using at least one meta tag describing a carrier attribute;
retrieve the at least one meta tag included in the strategic capacity profile, wherein meta tags assigned to carriers are dynamically updated to indicate changes to carrier attributes of the carriers;
identify one or more carriers that have the carrier attribute described by the at least one meta tag indicating that the one or more carriers are eligible to transport the freight load; and

provide, to a graphical user interface, carrier data for the one or more carriers to allow the one or more carriers to be selected to receive a tender of the freight load, wherein the carrier data displayed in the graphical user interface is updated in response to the at least one meta tag being dynamically updated. In one example of the system, the carrier data includes average pricing for transporting the freight load by the one or more carriers, which is calculated using final carrier bid data included in historical transaction data associated with the one or more carriers.

In one example of the system, the memory device further includes instructions that, when executed by the at least one processor, cause the system to determine a price at which to offer the tender for transporting the freight load, wherein the price is based in part on average pricing for transporting the load by the one or more carriers.

In one example of the system, the memory device further includes instructions that, when executed by the at least one processor, cause the system to send the tender to the one or more carriers selected.

In one example of the system, the transportation parameters for the freight load from the origin location to the destination location include a load type, load dimensions, a time frame for shipping the load, or price constraints.

In one example of the system, the carrier attributes described by the at least one meta tag includes a service attribute, an activity attribute, or a qualification attribute.

In one example of the system, the graphical user interface receives the transportation parameters for transporting the freight load.

In one example of the system, the memory device further includes instructions that, when executed by the at least one processor, cause the system to:
analyze carrier data for a plurality of carriers to identify services, activities, and qualifications of the plurality of carriers to provide transportation services; and
generate the meta tags for the carriers to describe the services, activities, and qualifications of the plurality of carriers.

In one example of the system, the memory device further includes instructions that, when executed by the at least one processor, cause the system to receive a selection of one or more meta tags to include in the strategic capacity profile that defines the strategy for transporting the load.

In one example there is provided, a computer implemented method, comprising:

analyzing carrier data for a plurality of carriers to identify services and qualifications of carriers to provide transportation services;

generating meta tags for the carriers to describe service attributes and qualification attributes of the carriers, wherein the meta tags are dynamically updated to indicate changes to the service attributes and the qualification attributes of the carriers;

creating a strategic capacity profile that defines a strategy for transporting a freight load from an origin location to a destination location, wherein the strategic capacity profile includes a selection of one or more of the meta tags that define the strategy for transporting the load;

receiving a request for a set of carriers having available capacity to transport the freight load;

retrieving the strategic capacity profile that defines the strategy for transporting the freight load;

identifying the set of carriers using in part the meta tags included in the strategic capacity profile, wherein the set of carriers have attributes that correspond to the service attributes and the qualification attributes described by the meta tags; and

providing, to a graphical user interface, carrier data for the set of carriers to allow one or more carriers to be selected to receive a tender of the freight load, wherein the carrier data displayed in the graphical user interface is updated in response to at least one of the meta tags being dynamically updated.

In one example of the computer implemented method, the method further comprises:

calculating an average price range for transporting the freight load for each carrier in the set of carriers using historical transaction data associated with the set of carriers; and

providing the average price range for the set of carriers.

In one example of the computer implemented method, the method further comprises generating a tender offer price range for transporting the load which is based in part on historical transaction data associated with the set of carriers.

In one example of the computer implemented method, the method further comprises sending tenders to the set of carriers, wherein a tender is transmitted to a carrier portal to allow a carrier to evaluate the tender.

In one example of the computer implemented method, the graphical user interface is provided for creating the meta tags and assigning the meta tags to the carriers.

In one example of the computer implemented method, the graphical user interface is provided for creating the strategic capacity profile, allowing a user to select the meta tags to be included in the strategic capacity profile.

In one example of the computer implemented method, creating the strategic capacity profile to define the strategy for transporting the load further comprises:

analyzing historical carrier transaction data associated with loads having the origin location and the destination location using machine learning to identify carrier attributes associated with optimized shipping performance; and

generating the strategic capacity profile to include a set of meta tags that describe carrier attributes.

In one example of the computer implemented method, identifying the set of carriers using in part the strategic capacity profile further comprises identifying the set of carriers using predictive analytics that selects the strategic capacity profile from a plurality of strategic capacity profiles.

In one example there is provided, a non-transitory machine readable storage medium including instructions embodied thereon for a graphical user interface, the instructions when executed by one or more processors:

send, to a transportation management service, transportation parameters for transporting a freight load from an origin location to a destination location,

wherein the transportation parameters allow a strategic capacity profile that corresponds to the transportation parameters to be identified where the strategic capacity profile defines a strategy for transporting the freight load using at least one meta tag describing a carrier attribute,

wherein the at least one meta tag is dynamically updated to indicate changes to the carrier attribute described by the at least one meta tag;

receive carrier data for a plurality of carriers that have the carrier attribute described by the at least one meta tag; and

display the carrier data for the plurality of carriers to allow one or more carriers to be selected to receive a tender of the freight load, wherein the carrier data displayed in the graphical user interface is updated in response to the at least one meta tag being dynamically updated.

In one example of the non-transitory machine readable storage medium, the non-transitory machine readable storage medium further includes instructions, that when executed by the one or more processors:

receive a filter parameter via the graphical user interface; and

filter the carrier data for the plurality of carriers displayed in the graphical user interface using the filter parameter.

In one example of the non-transitory machine readable storage medium, the non-transitory machine readable storage medium further includes instructions, that when executed by the one or more processors

calculate average pricing for transporting the freight load by a carrier, wherein the average pricing is calculated using the historical transaction data associated with the carrier; and

display the average pricing in the graphical user interface.

In one example of the non-transitory machine readable storage medium, the non-transitory machine readable storage medium further includes instructions, that when executed by the one or more processors, generate a tender offer price for transporting the load which is based in part on average pricing calculated using historical transaction data associated with a carrier.

In one example of the non-transitory machine readable storage medium, the non-transitory machine readable storage medium further includes instructions, that when executed by the one or more processors, receive an instruction to transmit a tender to a carrier portal associated with a carrier to allow the carrier to evaluate the tender.

In one example of the non-transitory machine readable storage medium, the at least one meta tag describes a service attribute or a qualification attribute of a carrier.

What is claimed is:

1. A system for freight transportation management, comprising:
at least one processor;
a memory device including instructions that, when executed by the at least one processor, cause the system to:
receive transportation parameters for transporting a freight load from an origin location to a destination location;
identify a strategic capacity profile that corresponds to the transportation parameters, wherein the strategic capacity profile defines a strategy for transporting the freight load using at least one meta tag describing a carrier attribute;
retrieve the at least one meta tag included in the strategic capacity profile, wherein meta tags assigned to carriers are dynamically updated to indicate changes to carrier attributes of the carriers;
identify one or more carriers that have the carrier attribute described by the at least one meta tag indicating that the one or more carriers are eligible to transport the freight load; and
provide, to a graphical user interface, carrier data for the one or more carriers to allow the one or more carriers to be selected to receive a tender of the freight load, wherein the carrier data displayed in the graphical user interface is updated in response to the at least one meta tag being dynamically updated.

2. The system in claim 1, wherein the carrier data includes average pricing for transporting the freight load by the one or more carriers, which is calculated using final carrier bid data included in historical transaction data associated with the one or more carriers.

3. The system in claim 1, wherein the memory device further includes instructions that, when executed by the at least one processor, cause the system to determine a price at which to offer the tender for transporting the freight load, wherein the price is based in part on average pricing for transporting the load by the one or more carriers.

4. The system in claim 1, wherein the memory device further includes instructions that, when executed by the at least one processor, cause the system to send the tender to the one or more carriers selected.

5. The system in claim 1, wherein the transportation parameters for the freight load include: the origin location, the destination location, a load type, load dimensions, a time frame for shipping the load, or price constraints.

6. The system in claim 1, wherein the carrier attribute described by the at least one meta tag includes a service attribute, an activity attribute, or a qualification attribute.

7. The system in claim 1, wherein the graphical user interface receives the transportation parameters for transporting the freight load.

8. The system in claim 1, wherein the memory device further includes instructions that, when executed by the at least one processor, cause the system to:
analyze carrier data for a plurality of carriers to identify services, activities, and qualifications of the plurality of carriers to provide transportation services; and
generate meta tags for the plurality of carriers to describe the services, activities, and qualifications of the plurality of carriers.

9. The system in claim 1, wherein the memory device further includes instructions that, when executed by the at least one processor, cause the system to receive a selection of one or more meta tags to include in the strategic capacity profile that defines the strategy for transporting the load.

10. A computer implemented method, comprising:
analyzing carrier data for a plurality of carriers to identify services and qualifications of carriers to provide transportation services;
generating meta tags for the carriers to describe service attributes and qualification attributes of the carriers, wherein the meta tags are dynamically updated to indicate changes to the service attributes and the qualification attributes of the carriers;
creating a strategic capacity profile that defines a strategy for transporting a freight load from an origin location to a destination location, wherein the strategic capacity profile includes a selection of one or more of the meta tags that define the strategy for transporting the load;
receiving a request for a set of carriers having available capacity to transport the freight load;
retrieving the strategic capacity profile that defines the strategy for transporting the freight load;
identifying the set of carriers using in part the meta tags included in the strategic capacity profile, wherein the set of carriers have attributes that correspond to the service attributes and the qualification attributes described by the meta tags; and
providing, to a graphical user interface, carrier data for the set of carriers to allow one or more carriers to be selected to receive a tender of the freight load, wherein the carrier data displayed in the graphical user interface is updated in response to at least one of the meta tags being dynamically updated.

11. The method in claim 10, further comprising:
calculating an average price range for transporting the freight load for each carrier in the set of carriers using historical transaction data associated with the set of carriers; and
providing the average price range for the set of carriers.

12. The method in claim 10 further comprising generating a tender offer price range for transporting the load which is based in part on historical transaction data associated with the set of carriers.

13. The method in claim 10, further comprising sending tenders to the set of carriers, wherein a tender is transmitted to a carrier portal to allow a carrier to evaluate the tender.

14. The method in claim 10, wherein the graphical user interface is provided for creating the meta tags and assigning the meta tags to the carriers.

15. The method in claim 10, wherein the graphical user interface is provided for creating the strategic capacity profile, allowing a user to select the meta tags to be included in the strategic capacity profile.

16. The method in claim 10, wherein creating the strategic capacity profile to define the strategy for transporting the load further comprises:
analyzing historical carrier transaction data associated with loads having the origin location and the destination location using machine learning to identify carrier attributes associated with optimized shipping performance; and
generating the strategic capacity profile to include a set of meta tags that describe carrier attributes.

17. The method in claim 10, wherein identifying the set of carriers using in part the strategic capacity profile further comprises identifying the set of carriers using predictive analytics to select the strategic capacity profile from a plurality of strategic capacity profiles.

18. A non-transitory machine readable storage medium including instructions embodied thereon for a graphical user interface, the instructions when executed by one or more processors:
send, to a transportation management service, transportation parameters for transporting a freight load from an origin location to a destination location,
wherein the transportation parameters allow a strategic capacity profile that corresponds to the transportation parameters to be identified where the strategic capacity profile defines a strategy for transporting the freight load using at least one meta tag describing a carrier attribute,
wherein the at least one meta tag is dynamically updated to indicate changes to the carrier attribute described by the at least one meta tag;
receive carrier data for a plurality of carriers that have the carrier attribute described by the at least one meta tag; and
display the carrier data for the plurality of carriers to allow one or more carriers to be selected to receive a tender of the freight load, wherein the carrier data displayed in the graphical user interface is updated in response to the at least one meta tag being dynamically updated.

19. The non-transitory machine readable storage medium in claim 18, further comprising instructions, that when executed by the one or more processors:
receive a filter parameter via the graphical user interface; and
filter the carrier data for the plurality of carriers displayed in the graphical user interface using the filter parameter.

20. The non-transitory machine readable storage medium in claim 18, further comprising instructions, that when executed by the one or more processors:
calculate average pricing for transporting the load by a carrier, wherein the average pricing is calculated using historical transaction data associated with the carrier; and
display the average pricing in the graphical user interface.

21. The non-transitory machine readable storage medium in claim 18, further comprising instructions, that when executed by the one or more processors, generate a tender offer price for transporting the load which is based in part on average pricing calculated using historical transaction data associated with a carrier.

22. The non-transitory machine readable storage medium in claim 18, further comprising instructions, that when executed by the one or more processors, receive an instruction to transmit a tender to a carrier portal associated with a carrier to allow the carrier to evaluate the tender.

23. The non-transitory machine readable storage medium in claim 18, wherein the at least one meta tag describes a service attribute or a qualification attribute of a carrier.
